(19) United States
(12) Patent Application Publication
(10) Pub. No.: US 2007/0263562 A1
(43) Pub. Date: Nov. 15, 2007

(54) WIRELESS DEVICE AND METHOD FOR IDENTIFYING MANAGEMENT FRAMES

(75) Inventor: CHENG-WEN TANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/563,151

(22) Filed: Nov. 25, 2006

(30) Foreign Application Priority Data
May 12, 2006 (TW) 95116844

(51) Int. Cl. H04Q 7/00

(52) U.S. Cl. 370/328

(57) ABSTRACT

A method for identifying management frames includes: receiving a management frame; determining a new state according to the management frame; transmitting a class frame to an expected source device according to the new state, wherein a class of the class frame is higher than that of a frame corresponding to the new state; determining whether an expected frame is received, wherein a type of the expected frame is the same as that of the management frame; and determining that the management frame is a true frame transmitted from the expected source device if the expected frame is received. A device employing the method is also provided.

### BACKGROUND OF THE INVENTION

1. Field of the Invention

The invention relates to network communications, and particularly to a wireless device and a method for identifying management frames.

2. Description of Related Art

Conventional mobile stations cannot identify authenticity of disassociation frames and deauthentication frames. If a mobile station communicating with an access point receives a disassociation frame or deauthentication frame from the access point, the mobile station will re-associate, re-authenticate with the access point, or start roaming.

Therefore, if an attacker creates a fake disassociation frame or deauthentication frame, and transmits the fake frame to the mobile station posing as the access point, the mobile station is prone to incur denial of service (DoS) attacks and continues seeking to re-associate or re-authenticate. The same situation will happen as well when the fake frame is transmitted to the access point. It is very difficult for the mobile station to avoid this kind of attack and the mobile station has to waste a lot of time to re-associate or re-authenticate with the access point.

### SUMMARY OF THE INVENTION

An exemplary embodiment of the present invention provides a wireless device that identifies management frames. The wireless device includes a receiving module, a state determination module, a transmitting module, and an identification module. The receiving module receives a management frame. The state determination module determines a new state according to the management frame. The transmitting module transmits a class frame to an expected source device according to the new state. A class of the class frame is higher than that of a frame corresponding to the new state. The identification module, for identifying the management frame, includes a frame determination submodule. The frame determination submodule determines whether an expected frame is received to determine whether the management frame is a true frame transmitted from the expected source device or a fake frame transmitted from an attacking device. A type of the expected frame is the same as that of the management frame.

Another exemplary embodiment of the present invention provides a method for identifying management frames. The method includes receiving a management frame; determining a new state according to the management frame; transmitting a class frame to an expected source device according to the new state, wherein a class of the class frame is higher than that of a frame corresponding to the new state; determining whether an expected frame is received, wherein a type of the expected frame is the same as that of the management frame; and determining that the management frame is a true frame transmitted from the expected source device if the expected frame is received.

Other advantages and novel features will become more apparent from the following detailed description when taken in conjunction with the accompanying drawings, in which:

### BRIEF DESCRIPTION OF THE DRAWINGS

FIG. 1 is a schematic diagram of a management frame of an exemplary embodiment of the present invention;

FIG. 2 is a schematic diagram of a wireless communication system and functional modules of a first wireless device of an exemplary embodiment of the present invention;

FIG. 3 is a schematic diagram of functional modules of a first wireless device of another exemplary embodiment of the present invention;

FIG. 4 is a schematic diagram of functional modules of a first wireless device of a further exemplary embodiment of the present invention;

FIG. 5 is a schematic diagram of functional modules of a first wireless device of a still further exemplary embodiment of the present invention;

FIG. 6 is a schematic diagram of a method for identifying management frames of an exemplary embodiment of the present invention;

FIG. 7 is a schematic diagram of a method for identifying management frames of another exemplary embodiment of the present invention;

FIG. 8 is a schematic diagram of a method for identifying management frames of a further exemplary embodiment of the present invention; and

FIG. 9 is a schematic diagram of a method for identifying management frames of a still further exemplary embodiment of the present invention.

### DETAILED DESCRIPTION OF THE INVENTION

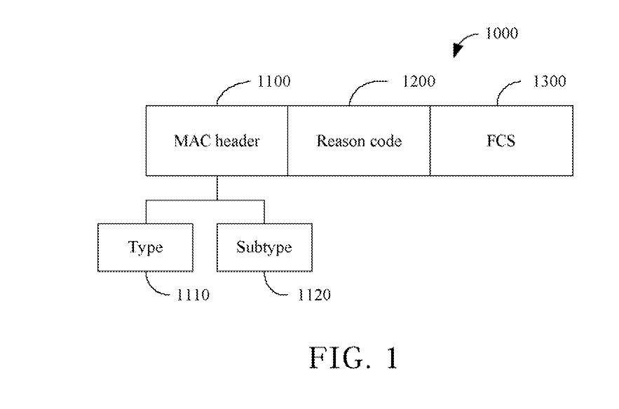

FIG. 1 is a schematic diagram of a management frame 1000 of an exemplary embodiment of the present invention. In the exemplary embodiment, the management frame 1000 may be a disassociation frame or deauthentication frame. The management frame 1000 includes a media access control (MAC) header 1100, a reason code 1200, and a frame check sequence (FCS) 1300. The MAC header 1100 includes a type field 1110 and a subtype field 1120.

The type field 1110 and the subtype field 1120 indicate a type of the management frame 1000. When the type field 1110 and the subtype field 1120 are respectively set to 00 and 1010, the management frame 1000 is a disassociation frame. When the type field 1110 and the subtype field 1120 are respectively set to 00 and 1100, the management frame 1000 is a deauthentication frame. In the exemplary embodiment, two management frames can be determined whether they are the same type according to the type fields 1110 and the subtypes 1120 of the two management frames, namely determining whether the two management frame are both disassociation frames or deauthentication frames.

The reason code 1200 indicates a reason for disassociation or deauthentication. In the exemplary embodiment, when the management frame 1000 is a disassociation frame, the reason code 1200 indicates a reason for disassociation. When the management frame 1000 is a deauthentication frame, the reason code 1200 indicates a reason for deauthentication.

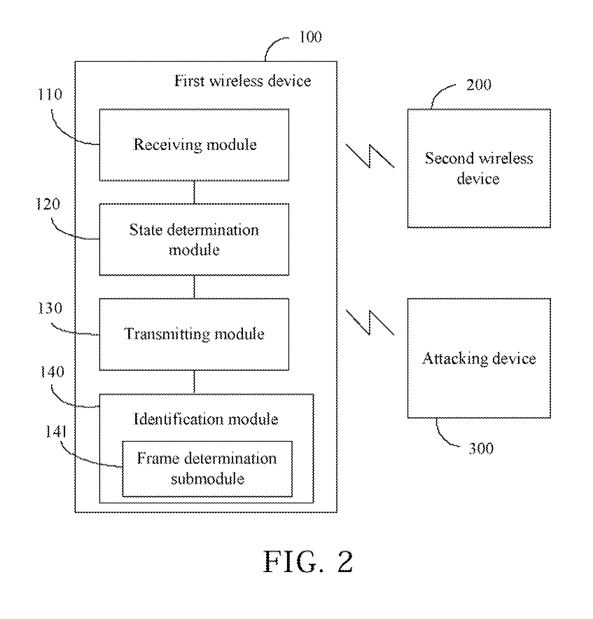

FIG. 2 is a schematic diagram of a wireless communication system and functional modules of a first wireless device 100 of an exemplary embodiment of the present invention. In the exemplary embodiment, the wireless communication system includes a first wireless device 100, a second wireless device 200, and an attacking device 300. The first wireless device 100 and the second wireless device 200 may respectively be a mobile station and an access point, or an access point and a mobile station. The attacking device 300 may be a mobile station with a frame generator.

The first wireless device 100 wirelessly communicates with the second wireless device 200. The second wireless device 200 may transmit a management frame to the first wireless device 100. The attacking device 300 may also transmit a management frame to the first wireless device 100 posing as the second wireless device 200 by using a media access control (MAC) address of the second wireless device 200. In the exemplary embodiment, the management frame is the management frame 1000 of FIG. 1. That is, the management frame may be a disassociation frame or deauthentication frame.

The first wireless device 100 receives the management frame, determines a new state according to the management frame, transmits a class frame to the second device 200 according to the new state, and then determines whether an expected frame is received from the second wireless device 200 to identify the management frame. That is, the first wireless device 100 determines whether the management frame is transmitted from the second wireless device 200. Therefore, denial of service (DoS) attacks are avoided.

As defined in the Institute of Electrical and Electronics Engineers (IEEE) 802.11 standard, states between the first wireless device 100 and the second wireless device 200 include State 1, State 2, and State 3. State 1 is an unauthenticated and unassociated state between the first wireless device 100 and the second wireless device 200. State 2 is an authenticated and unassociated state between the first wireless device 100 and the second wireless device 200. State 3 is an authenticated and associated state between the first wireless device 100 and the second wireless device 200.

Based on the three states between the first wireless device 100 and the second wireless device 200, frames between the first wireless device 100 and the second wireless device 200 are accordingly divided into three classes, namely Class1, Class 2, and Class3. Class 1, Class 2, and Class 3 respectively correspond to State 1, State 2, and State 3.

Referring to FIG. 2 again, the first wireless device 100 includes a receiving module 110, a state determination module 120, a transmitting module 130, and an identification module 140. The receiving module 110 receives a management frame. A source MAC address of the management frame is the MAC address of the second wireless device 200. In the exemplary embodiment, the management frame is the management frame 1000 of FIG. 1. That is, the management frame may be a disassociation frame or deauthentication frame. The management frame may be transmitted from the second wireless device 200 or the attacking device 300.

In the exemplary embodiment, if the management frame is transmitted from the second wireless device 200, the second wireless device 200 will determine that the state between the first wireless device 100 and the second wireless device 200 is changed from an old state to a new state. In this embodiment, if the management frame is a disassociation frame, the new state will be State 2. If the management frame is a deauthentication frame, the new state will be State 1.

Conversely, if the management frame is transmitted from the attacking device 300 instead of the second wireless device 200, the second wireless device 200 will consider the state between the first wireless device 100 and the second wireless device 200 is still the old state.

The state determination module 120 determines the new state according to the management frame, namely determining that the state between the first wireless device 100 and the second wireless device 200 is changed from the old state to the new state. In the exemplary embodiment, if the management frame is a disassociation frame, the new state is State 2. If the management frame is a deauthentication frame, the new state is State 1.

The transmitting module 130 transmits a class frame to an expected source device according to the new state. A class of the class frame is higher than that of a frame corresponding to the new state. Class 3 is highest and Class 1 is lowest. In the embodiment, the expected source device is the second wireless device 200, so a MAC address of the expected source device is the same as the source MAC of the management frame. In the exemplary embodiment, if the new state is State 2, the class of the class frame is Class 3. If the new state is State 1, the class of the class frame is Class 2 or Class 3.

In the exemplary embodiment, if the management frame is transmitted from the second wireless device 200, the second wireless device 200 will receive the class frame in the new state. According to the IEEE 802.11 standard, the second wireless device 200 must send back an expected frame to the first wireless device 100. A type/content of the expected frame is the same as that of the management frame. In the exemplary embodiment, when receiving a frame of Class 3 in State 2, the second wireless device 200 sends back a disassociation frame to the first wireless device 100. When receiving a frame of Class 2 or Class 3 in State 1, the second wireless device 200 sends back a deauthentication frame to the first wireless device 100.

Conversely, if the management frame is not transmitted from the second wireless device 200, the second wireless device 200 will receive the class frame in the old state, and the expected frame to the first wireless device 100 is not sent back to the first wireless device 100.

The identification module 140, for identifying the management frame, includes a frame determination submodule 141. The frame determination submodule 141 determines whether the expected frame is received to identify the management frame, namely determining whether the management frame is a true frame transmitted from the expected source device or a fake frame transmitted from the attacking device 300. The type of the expected frame is the same as that of the management frame. If the expected frame is received, the frame determination submodule 141 determines that the management frame is a true frame. That is, the management frame is transmitted from the second wireless device 200. If the expected frame is not received, the frame determination submodule 141 determines that the management frame is a fake frame. That is, the management frame is transmitted from the attacking device 300 instead of the second wireless device 200.

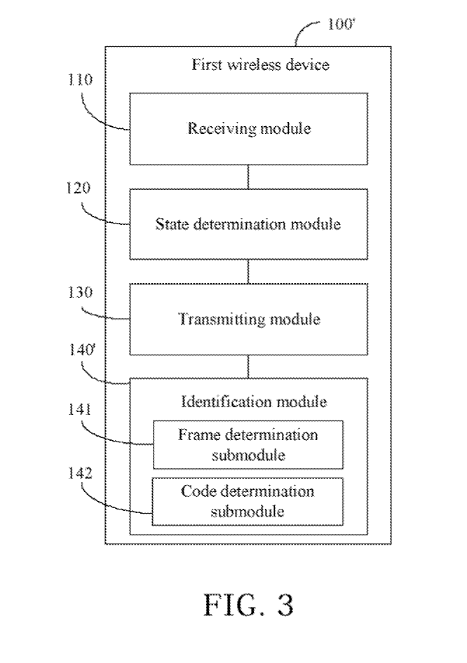

FIG. 3 is a schematic diagram of functional modules of a first wireless device 100′ of another exemplary embodiment of the present invention. An identification module 140′ of the first wireless device 100′ further includes a code determination submodule 142, and other modules of the first wireless device 100′ are the same as the first wireless device 100 of FIG. 2. The first wireless device 100′ can more accurately identify the management frame via the code determination submodule 142.

In the exemplary embodiment, the attacking device 300 may continuously attack the first wireless device 100′. That is, the expected frame may be still transmitted from the attacking device 300 instead of the second wireless device 200.

The expected frame belongs to the management frame 1000 of FIG. 1. The expected frame includes a reason code 1200. The reason code 1200 indicates a reason for disassociation or deauthentication. For example, if the reason code 1200 is set to 6, a Class 2 frame received from a non-authenticated station is indicated. If the reason code 1200 is set to 7, a Class 3 frame received from a non-associated station is indicated.

In the exemplary embodiment, if both the management frame and the expected frame, transmitted from the second wireless device 200, are disassociation frames, the reason code of the expected frame is set to 7, indicating a reason for disassociation. If both the management frame and the expected frame, transmitted from the second wireless device 200, are deauthentication frames, the reason code of the expected frame is set to 6, indicating a reason for deauthentication.

Conversely, if the management frame and the expected frame are transmitted from the attacking device 200, the reason code of the expected frame is set to a random digit by the attacking device 200.

The code determination submodule 142 determines whether the reason code of the expected frame is an expected value to identify the management frame. In the exemplary embodiment, if the expected frame is a disassociation frame, the expected value is 7. If the expected frame is a deauthentication frame, the expected value is 6.

In the exemplary embodiment, when the frame determination submodule 141 determines that the expected frame is received, the code determination submodule 142 determines whether the reason code of the expected frame is the expected value. If the reason code of the expected frame is the expected value, the code determination submodule 1 42 determines that the management frame is a true frame. If the reason code of the expected frame is not the expected value, the code determination submodule 142 determines that the management frame is a fake frame.

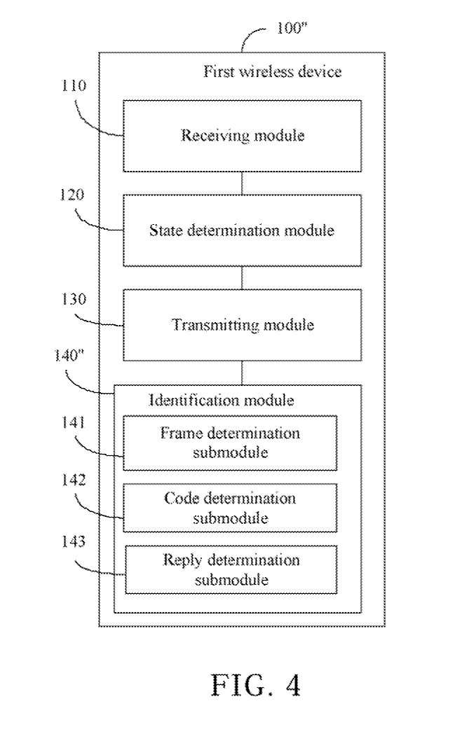

FIG. 4 is a schematic diagram of functional modules of a first wireless device 100″ of a further exemplary embodiment of the present invention. An identification module 140″ of the first wireless device 100″ further includes a reply determination submodule 143, and other modules of the first wireless device 100″ are the same as the first wireless device 100′ of FIG. 3. The first wireless device 100″ can more accurately identify the management frame via the reply determination submodule 143.

In the exemplary embodiment, the class frame is a request frame, namely a frame requiring the second wireless device 200 to reply. If the management frame is not transmitted from the second wireless device 200, the second wireless device 200 will receive the class frame in the old state. Therefore, the second wireless device 200 transmits a reply frame of the class frame to the first wireless device 100″.

Conversely, if the management frame is transmitted from the second wireless device 200, the second wireless device 200 will receive the class frame in the new state. Therefore, the second wireless device 200 will transmit the expected frame instead of the reply frame to the first wireless device 100″.

The reply determination submodule 143 determines whether the reply frame is received to identify the management frame. In the exemplary embodiment, when the code determination submodule 142 determines that the reason code of the expected frame is the expected value, the reply determination submodule 143 determines whether the reply frame is received. If the reply frame is not received, the reply determination submodule 143 determines that the management frame is a true frame. That is, the management frame is transmitted from the second wireless device 200. If the reply frame is received, the reply determination submodule 143 determines that the management frame is a fake frame. That is, the management frame is not transmitted from the second wireless device 200.

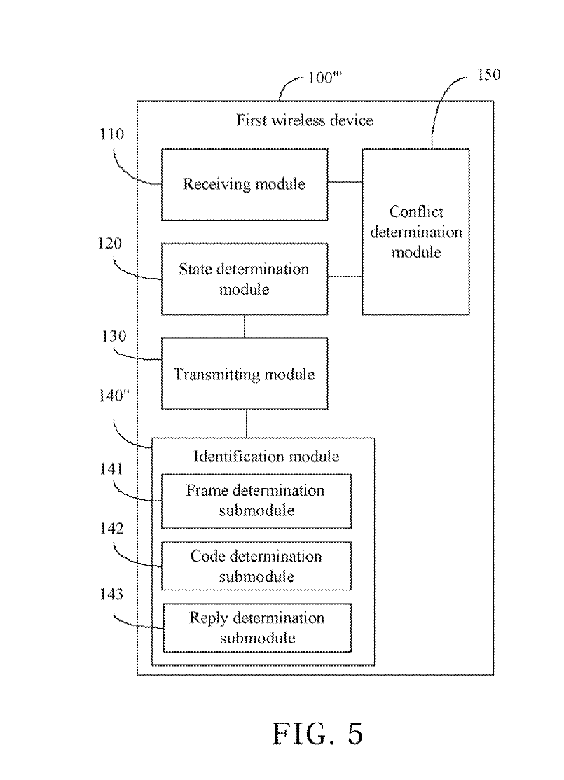

FIG. 5 is a schematic diagram of functional modules of a first wireless device 100′″ of a still further exemplary embodiment of the present invention. The first wireless device 100′″ further includes a conflict determination module 150, and other modules of the first wireless device 100′″ are the same as those of the first wireless device 100″ in FIG. 4. The first wireless device 100′″ can identify the management frame via the conflict determination module 150.

The conflict determination module 150 determines whether the reason code of the management frame conflicts with the old state to identify the management frame. In the exemplary embodiment, when the receiving module 110 receives the management frame, the conflict determination module 150 determines whether the reason code of the management frame conflicts with the old state.

For example, when the reason code of the management frame is set to 6, illustrating a Class 2 frame received from a non-authenticated station, the state between the first wireless device 100′″ and the second wireless device 200 is State 1. In such case, if the old state is State 2 or State 3, the reason code of the management frame conflicts with the old state. Therefore, the conflict determination module 150 determines that the management frame is a fake frame. Conversely, if the old state is State 1, the reason code of the management frame does not conflict with the old state. Then, the state determination module 120 determines the new state according to the management frame.

When the reason code of the management frame is 7, indicating a Class 3 frame received a non-associated station, the state between the first wireless device 100′″ and the second wireless device 200 is State 2. In such case, if the old state is State 1 or State 3, the reason code of the management frame conflicts with the old state. Therefore, the conflict determination module 150 determines that the management frame is a fake frame. Conversely, if the old state is State 2, the reason code of the management frame does not conflict with the old state. Then, the state determination module 120 determines the new state according to the management frame.

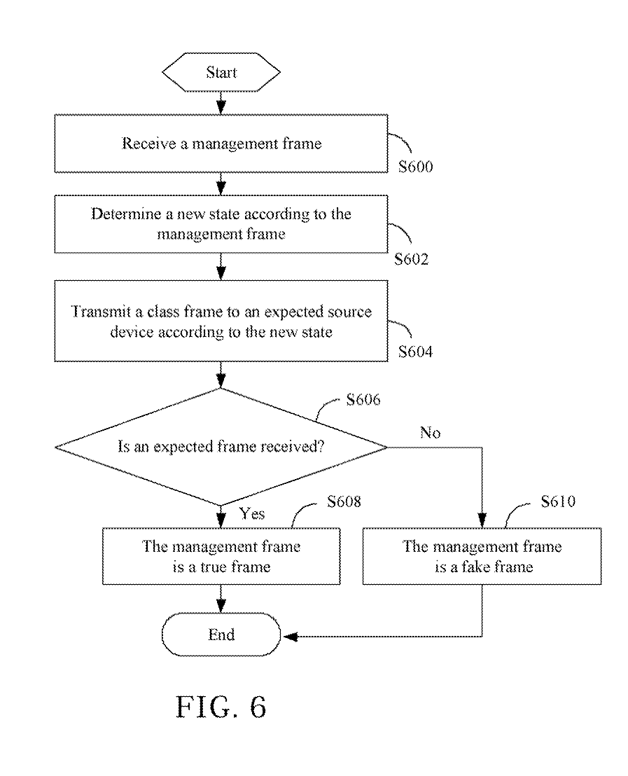

FIG. 6 is a schematic diagram of a method for identifying management frames of an exemplary embodiment of the present invention.

In step S600, the receiving module 110 of the first wireless device 100 receives a management frame. A source MAC address of the management frame is the MAC address of the second wireless device 200. In the exemplary embodiment, the management frame is the management frame 1000 of FIG. 1. That is, the management frame may be a disassociation frame or deauthentication frame.

In the exemplary embodiment, if the management frame is transmitted from the second wireless device 200, the second wireless device 200 will determine that the state between the first wireless device 100 and the second wireless device 200 is changed from an old state to a new state. In this embodiment, if the management frame is a disassociation frame, the new state is State 2. If the management frame is a deauthentication frame, the new state is State 1.

Conversely, if the management frame is transmitted from the attacking device 300 instead of the second wireless device 200, the second wireless device 200 will consider the state between the first wireless device 100 and the second wireless device 200 is still the old state.

In step S602, the state determination module 120 of the first wireless device 100 determines the new state according to the management frame. In the exemplary embodiment, if the management frame is a disassociation frame, the new state is State 2. If the management frame is a deauthentication frame, the new state is State 1.

In step S604, the transmitting module 130 of the first wireless device 100 transmits a class frame to an expected source device according to the new state. A class of the class frame is higher than that of a frame corresponding to the new state. The expected source device is the second wireless device 200, so a MAC address of the expected source device is the same as the source MAC address of the management frame. In the exemplary embodiment, if the new state is State 2, the class of the class frame is Class 3. If the new state is State 1, the class of the class frame is Class 2 or Class 3.

In the exemplary embodiment, if the management frame is transmitted from the second wireless device 200, the second wireless device 200 will receive the class frame in the new state. According to the IEEE 802.11 standard, the second wireless device 200 must send back an expected frame to the first wireless device 100. A type of the expected frame is the same as that of the management frame. For example, if receiving a frame of Class 3 in State 2, the second wireless device 200 sends back a disassociation frame to the first wireless device 100. If receiving a frame of Class 2 or Class 3 in State 1, the second wireless device 200 sends back a deauthentication frame to the first wireless device 100.

Conversely, if the management frame is not transmitted from the second wireless device 200, the second wireless device 200 will receive the class frame in the old state, and does not send back the expected frame to the first wireless device 100.

In step S606, the frame determination submodule 141 of the first wireless device 100 determines whether the expected frame is received. The type/content of the expected frame is the same as that of the management frame.

If the expected frame is received by the first wireless device 100, in step S608, the frame determination submodule 141 determines that the management frame is a true frame. That is, the management frame is transmitted from the second wireless device 200.

If the expected frame is not received, in step S610, the frame determination submodule 141 determines that the management frame is a fake frame. That is, the management frame is transmitted from the attacking device 300 instead of the second wireless device 200.

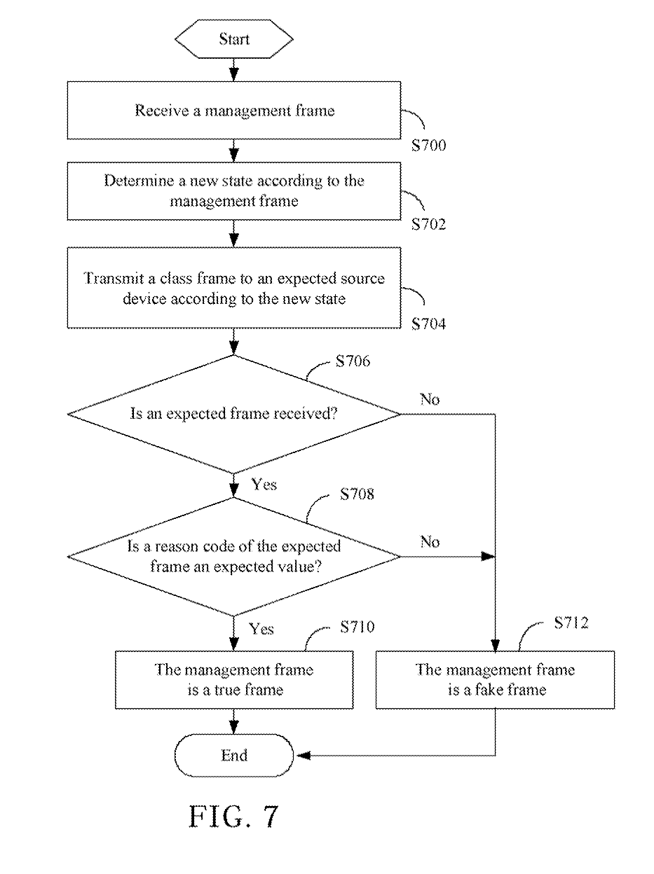

FIG. 7 is a schematic diagram of a method for identifying management frames of another exemplary embodiment of the present invention. Steps S700, S702, S704, and S706 of this embodiment are the same as steps S600, S602, S604, and S606 of FIG. 6, so descriptions are omitted.

In the exemplary embodiment, if both the management frame and the expected frame, transmitted from the second wireless device 200, are disassociation frames, the reason code of the expected frame indicates a reason for disassociation, namely being set to 7. If both the management frame and the expected frame, transmitted from the second wireless device 200, are deauthentication frames, the reason code of the expected frame indicates a reason for deauthentication, namely being set to 6.

Conversely, if the management frame and the expected frame are transmitted from the attacking device 200, the reason code of the expected frame is set to a random digit by the attacking device 200.

The difference between this embodiment and FIG. 6 is in that if the frame determination submodule 141 determines that the expected frame is received, in step S708, the code determination submodule 142 of the wireless device 100′ determines whether the reason code of the expected frame is an expected value. In the exemplary embodiment, if the expected frame is a disassociation frame, the expected value is 7. If the expected frame is a deauthentication frame, the expected value is 6.

If the expected frame is not received, in step S712, the frame determination submodule 141 of the first wireless device 100′ determines that the management frame is a fake frame.

If the reason code of the expected frame is the same as the expected value, in step S710, the code determination submodule 142 determines that the management frame is a true frame.

If the reason code of the expected frame is not the expected value, in step S712, the code determination submodule 142 determines that the management frame is a fake frame.

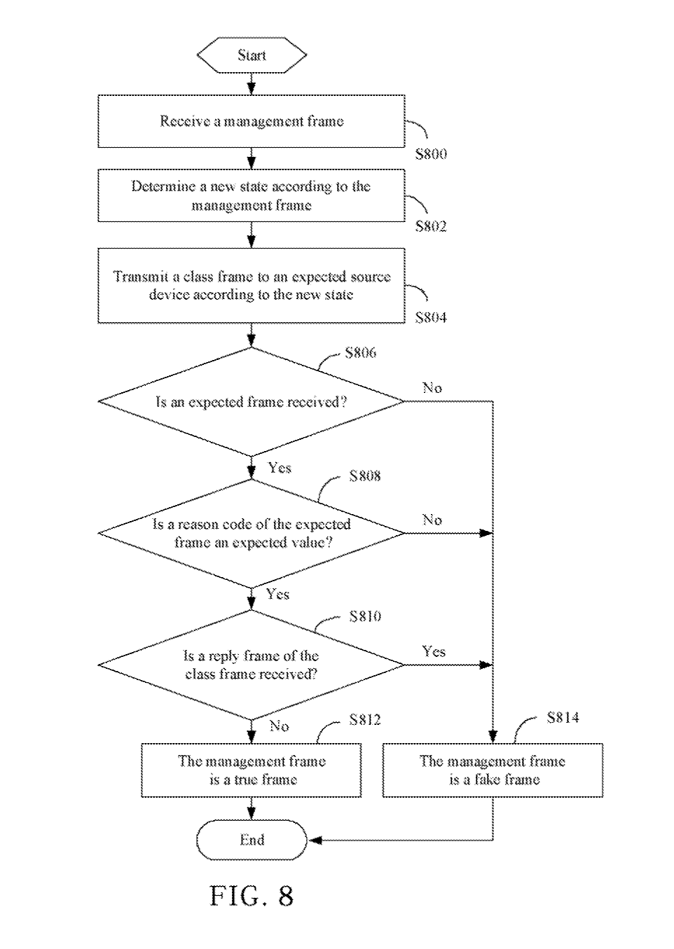

FIG. 8 is a schematic diagram of a method for identifying management frames of a further exemplary embodiment of the present invention. Steps S800, S802, S804, S806, and S808 of this embodiment are the same as steps S700, S702, S704, S706, and S708 of FIG. 7, so descriptions are omitted.

In the exemplary embodiment, the class frame is a request frame, for requesting the second wireless device 200 to reply. If the management frame is not transmitted from the second wireless device 200, the second wireless device 200 will receive the class frame in the old state. Therefore, the second wireless device 200 transmits a reply frame to the first wireless device 100″.

Conversely, if the management frame is transmitted from the second wireless device 200, the second wireless device 200 will receive the class frame in the new state. Therefore, the second wireless device 200 will transmit the expected frame instead of the reply frame to the first wireless device 100″.

The difference between this embodiment and FIG. 7 is in that if the code determination submodule 142 determines that the reason code of the expected frame is the expected value, in step S810, the reply determination submodule 143 of the first wireless device 100″ determines whether a reply frame of the class frame is received.

If the code determination submodule 142 determines that the reason code of the expected frame is not the expected value, in step S814, the code determination submodule 142 determines that the management frame is a fake frame.

If the reply frame of the class frame is not received, in step S812, the reply determination submodule 1 43 determines that the management frame is a true frame.

If the reply frame of the class frame is received, in step S814, the reply determination submodule 143 determines that the management frame is a fake frame.

In other embodiments, sequences of steps S806 and S810 may be exchanged, but step S808 must be after step S806.

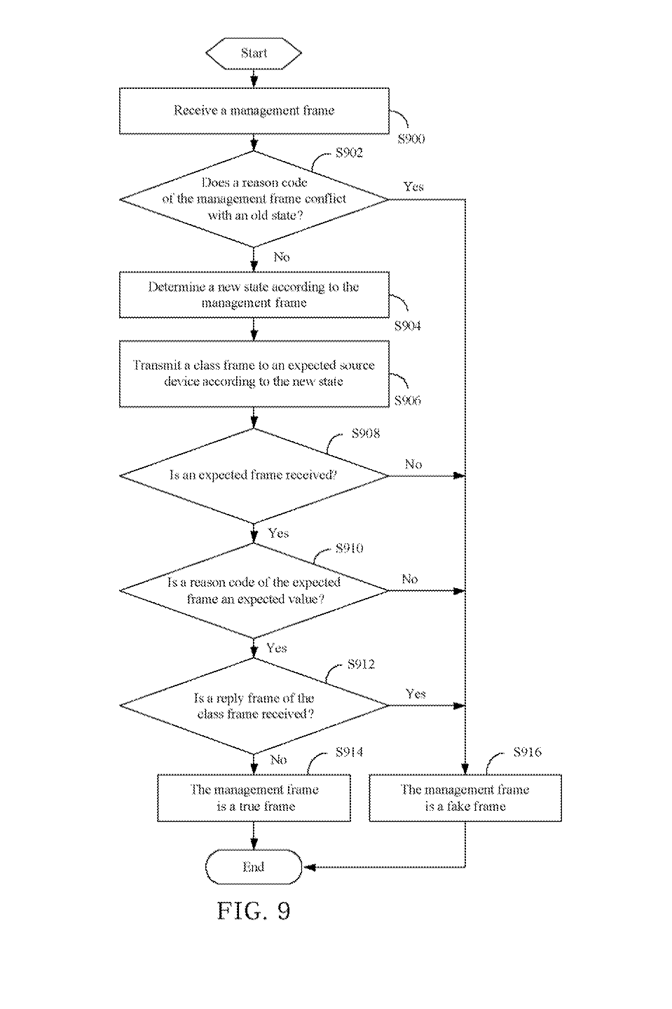

FIG. 9 is a schematic diagram of a method for identifying management frames of a still further exemplary embodiment of the present invention. Steps S900, S906, S908, S910, S912, and S914 of this embodiment are the same as steps S800, S804, S806, S808, S810, and S812 of FIG. 8, so descriptions are omitted.

The difference between this embodiment and FIG. 8 is in that when the receiving module 110 receives the management frame, in step S902, the conflict determination module 150 of the first wireless device 100′″ determines whether the reason code of the management frame conflicts with the old state.

If the reason code of the management frame does not conflict with the old state, in step S904, the state determination module 120 of the first wireless device 1000′″ determines the new state according to the management frame.

If the reason code of the management frame conflicts with the old state, in step S916, the conflict determination module 150 determines that the management frame is a fake frame.

In the embodiment of the present invention, the first wireless device 100′″ receives a management frame, and then identifies the management frame via the conflict determination module 150, the state determination module 120, the transmitting module 130, and the identification module 140″. Therefore, DoS attacks are avoided effectively.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A wireless device, for identifying management frames, comprising:
a receiving module, for receiving a management frame;
a state determination module, for determining a new state according to the management frame;
a transmitting module, for transmitting a class frame to an expected source device according to the new state, wherein a class of the class frame is higher than that of a frame corresponding to the new state; and
an identification module, for identifying the management frame, comprising:
a frame determination submodule, for determining whether an expected frame is received to determine whether the management frame is a true frame transmitted from the expected source device or a fake frame transmitted from an attacking device, wherein a type of the expected frame is the same as that of the management frame.

2. The wireless device as claimed in claim 1, wherein a media access control (MAC) address of the expected source device is the same as a source MAC address of the management frame.

3. The wireless device as claimed in claim 1, wherein the management frame comprises a media access control (MAC) header, a reason code, and a frame check sequence (FCS), and the expected frame comprises a MAC header, a reason code, and a FCS.

4. The wireless device as claimed in claim 3, wherein the management frame and the expected frame are disassociation frames.

5. The wireless device as claimed in claim 3, wherein the management frame and the expected frame are deauthentication frames.

6. The wireless device as claimed in claim 3, wherein the identification module further comprises a code determination submodule, for determining whether the reason code of the expected frame is an expected value to identify the management frame.

7. The wireless device as claimed in claim 6, wherein the identification module further comprises a reply determination submodule, for determining whether a reply frame of the class frame is received to identify the management frame.

8. The wireless device as claimed in claim 3, further comprising a conflict determination module, for determining whether the reason code of the management frame conflicts with an old state to identify the management frame.

9. A method for identifying management frames, comprising:
receiving a management frame;
determining a new state according to the management frame;
transmitting a class frame to an expected source device according to the new state, wherein a class of the class frame is higher than that of a frame corresponding to the new state;
determining whether an expected frame is received, wherein a type of the expected frame is the same as that of the management frame; and
determining that the management frame is a true frame transmitted from the expected source device if the expected frame is received.

10. The method as claimed in claim 9, wherein a media access control (MAC) address of the expected source device is the same as a source MAC address of the management frame.

11. The method as claimed in claim 9, wherein the management frame comprises a media access control (MAC) header, a reason code, and a frame check sequence (FCS), and the expected frame comprises a MAC header, a reason code, and a FCS.

12. The method as claimed in claim 11, wherein the management frame and the expected frame are disassociation frames.

13. The method as claimed in claim 11, wherein the management frame and the expected frame are deauthentication frames.

14. The method as claimed in claim 11, further comprising:
determining whether the reason code of the expected frame is an expected value; and
determining that the management frame is a true frame transmitted from the expected source device if the reason code of the expected frame is the expected value.

15. The method as claimed in claim 14, further comprising:
determining whether a reply frame of the class frame is received; and
determining that the management frame is a fake frame transmitted from an attacking device if the reply frame of the class frame is received.

16. The method as claimed in claim 11, further comprising:
determining whether the reason code of the management frame conflicts with an old state; and
determining that the management frame is a true frame transmitted from the expected source device if the reason code of the management frame does not conflict with the old state.

17. A method for identifying management frames in a wireless device, comprising steps of:
receiving a management frame in a first wireless device;
determining a new state for said management frame according to said management frame;
transmitting a class frame to a second wireless device to be authenticated to and associated with said first wireless device according to said new state for said management frame; and
determining that said management frame is a frame transmitted from said second wireless device when an expected frame is received in response to transmission of said class frame.

18. The method as claimed in claim 17, wherein a class of said class frame is higher than that of said management frame corresponding to said new state for said management frame.

19. The method as claimed in claim 17, wherein a type of said expected frame is same as that of said management frame.
